(19) United States
(12) Patent Application Publication
(10) Pub. No.: US 2025/0201865 A1
(43) Pub. Date: Jun. 19, 2025

(54) METHOD FOR MANUFACTURING A BIPOLAR PLATE MADE OF CARBON FIBERS

(71) Applicant: HYCCO, TOULOUSE (FR)

(72) Inventors: Romain DI COSTANZO, TOULOUSE (FR); Alain FONTAINE, TOULOUSE (FR); Vivien NOURI, SAINT ORENS DE GAMEVILLE (FR)

(73) Assignee: HYCCO, TOULOUSE (FR)

(21) Appl. No.: 18/845,232

(22) PCT Filed: Mar. 30, 2024
(86) PCT No.: PCT/EP2023/058382

§ 371 Date: Sep. 9, 2024

(30) Foreign Application Priority Data
Mar. 31, 2022 (FR) 2202914

(51) Int. Cl. H01M 8/0234; H01M 8/0239; H01M 8/0243; H01M 8/0254; H01M 8/18

(52) U.S. Cl. CPC H01M 8/0234; H01M 8/0239; H01M 8/0243; H01M 8/0254; H01M 8/188

(57) ABSTRACT

A method for manufacturing a bipolar plate comprising a step of superposing, along a stack axis (A), a first release film (4), at least one carbon reinforcing film (2), at least one thermosetting resin film (3) and a second release film (4), in order to form a stack (1), and a step of pressurizing the stack (1) in a compression system, the pressurizing step being carried out at a predetermined forming pressure and a predetermined forming temperature for a second predetermined time. The carbon reinforcing film (2) is a nonwoven reinforcing film (2) comprising a plurality of reinforcing fibers (21), each reinforcing fiber (21) extending along an orientation axis (F), the orientation axis (F) of at least 10% to 60% of the reinforcing fibers (21) is oriented along the stack axis (A).

### TECHNICAL FIELD

This invention relates to the field of electrochemical devices and in particular to a method for manufacturing bipolar plates made of composite material, configured to be mounted in an electrochemical device.

An electrochemical device is any device allowing to implement an electrochemical reaction, such as a fuel cell or a proton exchange membrane electrolyzer, allowing to generate electrical energy or hydrogen respectively from a redox reaction. The term “electrochemical device” also refers to a redox flow battery used to generate electrical energy from potential energy stored in the battery.

In a known way, an electrochemical device comprises a stack of a plurality of cells extending along a stack axis and two end plates, placed at the ends of the stack. The end plates are connected by compression members that allow to compress the cells and ensure the sealing of the electrochemical device.

With reference to FIG. 1, representing an electrochemical device 100, each cell 110 comprises, in a known manner, a membrane-electrode assembly 120 and two bipolar plates 130, also referred to as separator plates, which sandwich the membrane-electrode assembly 120 and allow the distribution of fluids in the cell 110. To form the electrochemical reaction in the electrochemical device, each cell 110 is supplied with an oxidizing fluid and a reducing fluid, for example dihydrogen and dioxygen, which circulate on either side of a membrane and react by means of a catalyst. Each cell 110 is also supplied with a heat transfer fluid, used to regulate the temperature of the electrochemical device. In practice, two adjacent bipolar plates 130A, 130B of two adjacent cells 110A, 110B are secured together so as to form several internal channels 140 which allow the heat transfer fluid to pass between the cells 110.

With reference to FIGS. 2 and 3, a bipolar plate 130 comprises, in known manner, a plurality of openings 131, which allow the entry and the exit of the oxidizing and reducing fluids, and two inlet and outlet openings 132 for the heat transfer fluid. Each bipolar plate 130 also comprises an active central portion 133, in contact with the membrane-electrode assembly and on which the redox reaction occurs, and a peripheral portion 134 allowing two bipolar plates 130 to be secured together.

The active portion 133 comprises concave portions 135 and convex portions 136 (shown in FIG. 3 presenting a cross-sectional view of the bipolar plate 130 in a plane A: A shown in [FIG. 2]) which allow fluids to flow between the various inlet/outlet openings 131, 132. The concave portions 135 of two bipolar plates 130 are secured together so that the convex portions 136 form the internal channels 140 (shown in FIG. 1) for the circulation of the heat transfer fluid.

In the prior art, bipolar plates made of graphite or metal (e.g., stainless steel, Inconel, aluminum or titanium) covered with a protective coating so as to limit the impact of corrosion caused by the electrochemical device are known. However, such bipolar plates have a number of disadvantages. The graphite bipolar plates are heavy and have an important overall dimension because they are generally thicker than 2 mm. The metal bipolar plates have a high mass and a limited service life, given the acidic and corrosive environment of the electrochemical devices wherein they are mounted, despite the protective coating used.

As a result, the bipolar plates are increasingly being made from composite materials. A bipolar plate comprising conductive elements dispersed in a resin is known for this purpose. The conductive elements include carbon black, ground carbon fiber, graphite, expanded graphite, carbon nanotube or graphene. The resin is generally a thermoplastic or thermosetting polymer. When forming such a bipolar plate, the resin in its viscous state is mixed with a very large number of conductive elements (generally more than 85% of conductive elements for the bipolar plate as a whole, to ensure a high conductivity). The bipolar plate is formed by injecting the resin loaded with conductive elements into a mold or molded by pressing in a thermocompression press.

However, the massive addition of conductive elements significantly increases the viscosity of the thermoset or thermoplastic resin, making the mixture thicker. The manufacturing methods described above do not allow to manufacture thin bipolar plates and the bipolar plate is often very thick, generally more than 2 mm, which increases the overall dimension and the weight of the electrochemical device. This is a disadvantage for an electrochemical device configured to be integrated, for example, into an aircraft or any other mobility application. In addition, the injection molding or the thermocompression molding leaves a resin surface layer, which can be caused by the use of releasing products for example, and which increases the electrical contact resistance, which is detrimental for an electrochemical conversion device application where this value must be minimized. In order to reduce the electrical contact resistance, the bipolar plate needs to be post-treated, either by chemical or mechanical treatment, by abrasion for example.

A bipolar plate made of a composite material comprising reinforcement fibers (e.g., carbon fibers) impregnated with a thermoplastic or thermosetting polymer resin is known in the prior art. Such a bipolar plate has the advantage of being thinner (less than 1 mm thick), which allows to limit its overall dimension and its weigh.

However, in such a bipolar plate, the thermoplastic resin forms a residual layer on the surface, similar to an insulating skin, which can affect the electrical conductivity. It is then necessary to proceed to an exposition of the reinforcement fibers on the surface of the bipolar plate. Such treatment, carried out for example by sanding or dissolution by plasma irradiation, can damage the reinforcement fibers and affect the mechanical properties of the bipolar plate, which is a significant disadvantage. Also known from the document WO2016182131A1 is the use of a sacrificial film allowing to expose the reinforcement fibers on the surface of the bipolar plate without damaging them. The bipolar plates are then manufactured using thermocompression, allowing thin, lightweight bipolar plates to be manufactured. However, in the document WO2016182131A1, the manufacturing method does not allow a bipolar plate using a carbon fiber reinforcement to be produced simply and quickly.

In addition, the use of reinforcement fibers requires a very high forming pressure (generally in excess of 15 MPa), to allow the fibers to be properly impregnated, to reduce the porosities and to expose the fibers on the surface to allow a good electrical conductivity. A significant pressure can deform the initial weave of the reinforcement and lead to the formation of porous cavities that can alter the gas impermeability of the bipolar plates.

The invention thus aims to eliminate at least some of these disadvantages by proposing a method for manufacturing a bipolar plate that is simple, fast and does not require the use of expensive industrial machinery, allowing the formation of a thin and lightweight bipolar plate.

### SUMMARY

The invention relates to a method for manufacturing a bipolar plate, the bipolar plate being configured to be mounted in an electrochemical device, the electrochemical device being configured to implement an electrochemical reaction, the method comprising:
a step of superimposing, along a stack axis Z, a first releasing film, at least one reinforcement film, at least one thermoplastic resin film and a second releasing film, in order to form a stack,
a step of positioning the stack in a compression system,
a step of pressurizing the stack in the compression system, the pressurizing step being carried out at a predetermined forming pressure and a predetermined forming temperature for a second predetermined period of time, so as to melt the thermoplastic resin of the thermoplastic resin film and impregnate the reinforcement film with the thermoplastic resin to form a bipolar plate.

The manufacturing method is remarkable in that the reinforcement film is a non-woven carbon reinforcement film comprising a plurality of reinforcement fibers, each reinforcement fiber extending along an axis of orientation, the ratio of reinforcement fibers oriented along the stack axis Z is between 10% and 60%.

Advantageously, a non-woven carbon reinforcement film allows a lower forming pressure to be applied than the pressure used for a woven reinforcement film, which allow the use of industrial machinery less expensive, allowing a simpler and faster manufacturing method. A lower forming pressure also allows to limit the deformation of the initial weave of the reinforcement and the formation of porous cavities that could affect the gas impermeability of the bipolar plates.

Orienting the reinforcement fibers along the stack axis allows to increase the electrical conductivity of the material along this axis, so as to ensure an optimum electrical transport between the faces of the bipolar plate for use in electrochemical devices.

A ratio of reinforcement fibers oriented along the stack axis of between 10% and 60% provides a good conductivity in the bipolar plate while ensuring that the bipolar plate has a high mechanical resistance. Such a high ratio of reinforcement fibers oriented along the stack axis Z allows to fulfil a dual function of mechanical and electrical conductivity.

Preferably, the reinforcement fibers are oriented by stitching. Some of the reinforcement fibers can be mechanically oriented along the stack axis Z by means of stitching, which improves the electrical conductivity in the bipolar plate, allowing better electrical exchanges in the cells adjacent to the bipolar plate when the latter is mounted in an electrochemical device.

Alternatively, the orientation of the reinforcement fibers can be carried out by a different method, for example by hydroentanglement.

In a preferred embodiment, the ratio of reinforcement fibers oriented along the stack axis Z is between 15 and 45%, allowing an optimum conductivity in the bipolar plate. This ratio also means that the ratio of non-oriented reinforcement fibers remains high enough to guarantee an optimum mechanical strength of the bipolar plate.

Preferably, as the non-woven carbon reinforcement film comprises open porosities, the non-woven carbon reinforcement film comprises an open porosity ratio greater than 60% before the pressurization step. The term “open porosity” will be described in more detail later.

In one embodiment, the non-woven carbon reinforcement film comprises an open porosity ratio of between 60% and 70%. Studies have shown that certain materials, such as carbon papers or gas diffusion layers, which are particularly effective for manufacturing a thin, strong, lightweight bipolar plate, can have this ratio of open porosity.

Preferably, the non-woven carbon reinforcement film is a carbon felt. A carbon felt comprises a high ratio of open porosity in the reinforcement film, preferably greater than 70%, allowing an optimum flow of the thermoplastic resin in the reinforcement film and more specifically between the reinforcement fibers. In this way, the reinforcement fibers are optimally impregnated with thermoplastic resin, resulting in a bipolar plate with a high level of consolidation and few pores. By “open porosity” we mean cavities or porosity channels open towards the outside of the reinforcement film. The open porosities are accessible from the outside and can be filled with polymer resin to ensure the mechanical strength of the bipolar plate. A carbon felt also allows the use of a known material, traditionally used as a thermal insulator or as a medium allowing the diffusion of liquid electrolyte in the case of a redox flow battery.

Preferably, as the non-woven carbon reinforcement film comprises open porosities, the non-woven carbon reinforcement film comprises an open porosity ratio of more than 80% before the pressurization step. This ratio of open porosity also allows an optimum deformation of the reinforcement film, allowing a high compressibility and an adaptation of the reinforcement film to complex forms. Even more preferably, the non-woven carbon reinforcement film comprises a ratio of open porosity of more than 90%. Hereafter, for the sake of brevity, the “open porosity ratio” can be referred to as “open porosity”.

A high open porosity in the reinforcement film combined with an optimum ratio of reinforcement fibers oriented along the stack axis Z has the advantage of providing optimum performance for the use of the bipolar plate in an electrochemical system. In particular, a high level of open porosity, combined with a high ratio of reinforcement fibers oriented along the stack axis Z, allows both a high conductivity of the bipolar plate, allowing it to fulfil its role as a conductive element in an optimum manner, and a high porosity of the reinforcement, allowing a good impregnation and a significant deformation of the reinforcement at low pressure in order to correctly form the channels of the bipolar plate, and obtain a composite with negligible porosities to hydrogen in order to fulfil its role as a fluid separator.

Preferably, said open porosities have a diameter of between 1 μm and 250 μm. Preferably, at least 50% of the open porosities in the reinforcement film have a diameter greater than 125 μm. Even more preferably, at least 50% of the open porosities in the reinforcement film have a diameter greater than 150 μm. Such porosities can easily be filled by the polymer resin without affecting the mechanical strength of the bipolar plate. The size of the porosities also means that the assembly is highly compressible, allowing to manufacture thin bipolar plates. The expression “diameter of open porosities” means the diameter of an equivalent circle, i.e. the diameter of a circle with a surface area equivalent to the surface area of the porosity. In a similar way, it is more precisely described here that, preferably, at least 50% of the surface area of the open porosities of the reinforcement film is occupied by porosities whose equivalent circle diameter is greater than 125 μm.

Preferably, said open porosities have an equivalent circle diameter of between 1 μm and 300 μm. In one embodiment, at least 50% of the surface area of the open porosities of the reinforcement film is occupied by porosities with an equivalent circle diameter greater than 30 μm. Even more preferably, at least 50% of the surface area of the open porosities of the reinforcement film is occupied by porosities whose equivalent circle diameter is greater than 80 μm, preferably greater than 90 μm.

The preferred forming temperature is between 14° and 400° C., allowing a wide range of thermoplastic polymer families to be implemented.

In one embodiment, the forming temperature is between 24° and 360° C., allowing polymers of the polyphenylene sulphide PPS or polyphenyl sulphone PPSU type to be formed.

In one embodiment, the forming temperature is between 20° and 260° C., allowing polyvinylidene fluoride (PVDF) or polyamide type polymers to be formed.

In one embodiment, the forming temperature is between 14° and 200° C., allowing polyolefin-type polymers to be formed.

In one embodiment, the forming temperature is between 35° and 400° C., allowing polymers of the polyaryl ether ketone type (PEEK, PEK, PEKK, etc.) to be formed.

Preferably, the predetermined forming pressure is between 6 and 12 MPa. Thanks to the non-woven carbon, such a forming pressure is sufficient to optimally impregnate the reinforcement fibers in the reinforcement film and benefit from a bipolar plate with a high level of consolidation and therefore a significant impermeability of the bipolar plates to hydrogen in an electrochemical device.

Preferably, the predetermined forming pressure is between 8 and 10 MPa. Thanks to the invention, it is not necessary to raise the forming pressure to a too high pressure. This eliminates the need for particularly expensive industrial machinery. The manufacturing method is faster and simpler to implement, while allowing high manufacturing rates. This forming pressure also limits the deformation of the reinforcement fibers in the initial reinforcement film, which could generate porous cavities in the bipolar plate, thereby guaranteeing the effectiveness of the bipolar plate by limiting any risk of malfunction.

Preferably, the reinforcement film is less than 5 mm thick. The reinforcement film is thick enough to produce a bipolar plate with high mechanical resistance, yet flexible enough to allow the reinforcement film to adapt to complex geometries. Preferably, the initial thickness of the reinforcement film (i.e., the thickness before the stack is compressed to form the bipolar plate) is between 0.5 and 3.4 mm, to allow the formation of bipolar plates with a thickness of less than 0.5 mm after compression of the stack.

Preferably, the reinforcement film has a mass per unit area of 500 g/m² or less, allowing to form a lightweight bipolar plate. Preferably, the mass per unit area is between 50 and 400 g/m². Even more preferably, the mass per unit area is between 50 and 300 g/m², allowing the bipolar plate formed to be integrated into an electrochemical device, for example in an aircraft or other vehicle, where the mass constraints are important.

In one embodiment, the manufacturing method comprises, subsequent to the pressurization step, a step of cooling the formed bipolar plate for a third predetermined period of time.

In a first embodiment, the cooling step is carried out at a cooling rate of between 1° and 100° C./min. Such a high cooling rate allows the crystalline part of the semi-crystalline polymers to develop, so that the bipolar plate manufactured has a good impermeability to the fluid used for energy conversion in the electrochemical device. At this cooling rate, a crystallization ratio of between 43 and 47% can be achieved, corresponding to a crystallization ratio close to the maximum crystallization ratio that can be achieved with the thermoplastic resins used, generally in the region of 40 to 55%. Studies have shown that the maximum ratio of crystallization that can be achieved with other types of thermoplastic resin, for example polyaryl ether ketones, is between 20 and 40%. Similarly, the maximum ratio of crystallization that can be achieved with different types of thermoplastic resins, such as polyolefins, is between 55 and 80%.

Alternatively, for polymers referred to as “amorphous” polymers, i.e., the polymers which do not comprise crystalline parts, the cooling step is carried out at a cooling rate of more than 80° C./min, so as to cool the bipolar plate rapidly, allowing faster production rates.

Preferably, the cooling rate is between 4° and 90° C./min. Such a cooling rate allows the optimum development of the crystalline part of the stack, while minimizing the cooling time of the bipolar plate to reduce the manufacturing cycles and allow a rapid method allowing high production rates.

The invention also relates to a bipolar plate, configured to be mounted in an electrochemical device, the bipolar plate being manufactured by means of the manufacturing method as previously described.

According to one aspect, the bipolar plate comprises a non-woven carbon reinforcement film comprising a plurality of reinforcement fibers, each reinforcement fiber extending along an axis of orientation, the ratio of reinforcement fibers oriented along the stack axis Z being between 10% and 60%.

Preferably, the bipolar plate has a thickness of less than or equal to 0.5 mm, which advantageously allows both to limit the mass and the overall dimension of the electrochemical device and to increase its power density (number of kW/kg). The electrochemical device can therefore be easily mounted in a vehicle such as an aircraft.

Even more preferably, the bipolar plate is less than 0.4 mm thick.

Preferably, the bipolar plate has a specific electrical surface resistance of less than 12 mΩ·cm².

Preferably, the bipolar plate has a porosity ratio of less than 1%, ensuring an optimum permeability to the bipolar plate.

### PRESENTATION OF DRAWINGS

The invention will be better understood on reading the following description, given by way of example, with reference to the following figures, given by way of non-limiting examples, wherein identical references are given to similar objects.

FIG. 1 is a schematic representation of a stack of membrane-electrode assemblies and bipolar plates in an electrochemical device.

FIG. 2 is a schematic representation of a bipolar plate from FIG. 1.

FIG. 3 is a schematic representation of a cross-sectional view of the bipolar plate in FIG. 2,

FIG. 4 is a schematic representation of a stack of a non-woven carbon reinforcement film, a thermoplastic resin film and two releasing films for the manufacture of a bipolar plate according to the invention.

FIG. 5 is a close-up view of the non-woven reinforcement film of FIG. 4.

FIG. 6 is a schematic representation of a first step of the manufacturing method according to one embodiment of the invention.

FIG. 7 is a schematic representation of a second step of the manufacturing method according to one embodiment of the invention.

FIG. 8 is a schematic representation of a third step of the manufacturing method according to one embodiment of the invention.

FIG. 9 is a schematic representation of a fourth step of the manufacturing method according to one embodiment of the invention.

FIG. 10 is a schematic representation of a fifth step of the manufacturing method according to one embodiment of the invention.

FIG. 11 is a graph representing the evolution of temperature and pressure during a manufacturing method according to the invention.

FIG. 12 is a schematic representation of a sixth step of the manufacturing method according to one embodiment of the invention.

FIG. 13 is a schematic representation of a bipolar plate manufactured using the manufacturing method according to the invention.

FIG. 14 is a schematic representation of an image resulting from tomographic characterization of a reinforcement film.

FIG. 15 is a schematic representation of a skeletonization of the reinforcement fibers of the reinforcement film shown in FIG. 14.

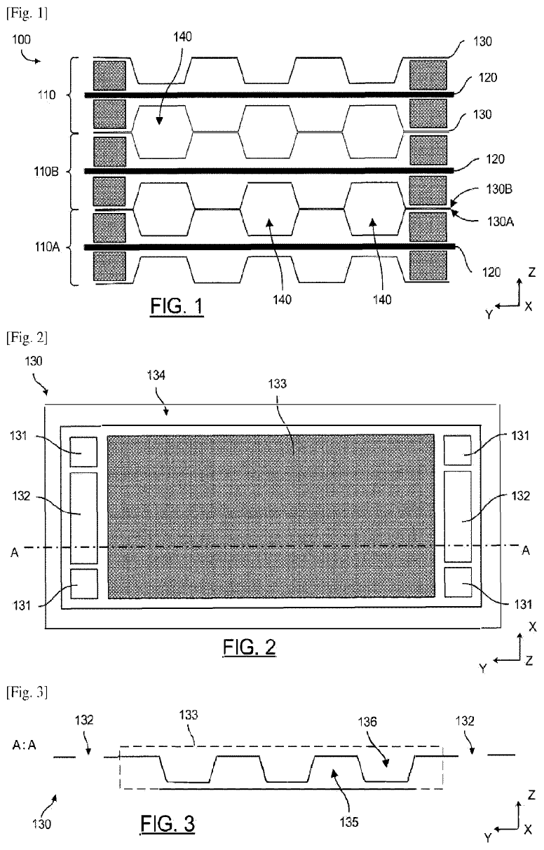

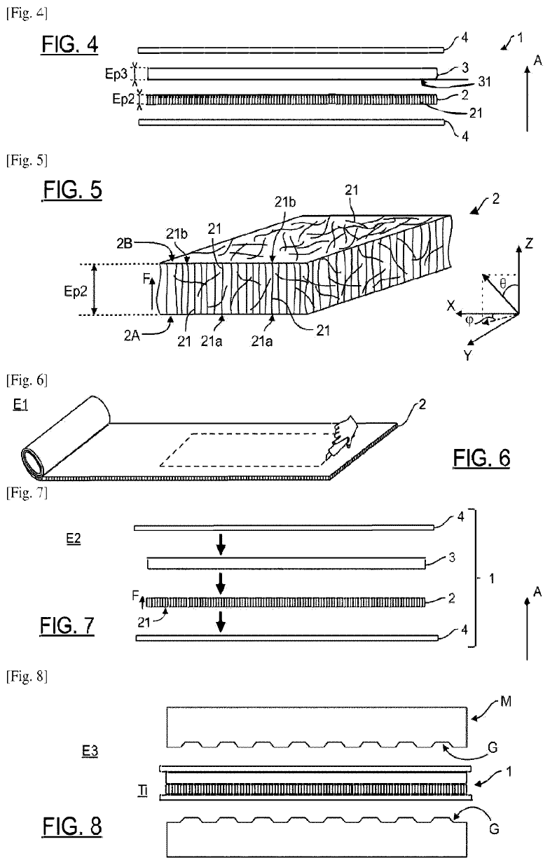

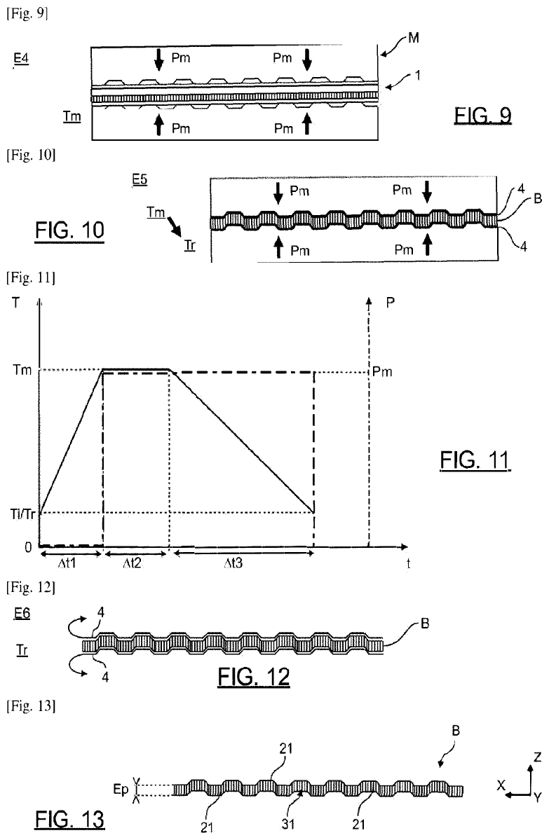

It should be noted that the figures set out the invention in detail in order to implement the invention, said figures of course being able to be used to better define the invention if necessary.

### DETAILED DESCRIPTION

The invention relates to a method for manufacturing a bipolar plate made of composite material for an electrochemical device.

Hereafter, as described above, the term “electrochemical device” refers equally to a fuel cell, a proton exchange membrane electrolyzer, a redox flow battery or any other device allowing to implement an electrochemical reaction.

As previously described, an electrochemical device comprises a stack of a plurality of cells, each comprising a membrane-electrode assembly and two bipolar plates, also referred to as separator plates, which sandwich the membrane-electrode assembly and allow the distribution of fluids within the cell. To form the electrochemical reaction in the electrochemical device, each cell is, in a known way, supplied with an oxidizing fluid and a reducing fluid, for example dihydrogen and dioxygen, which react when they are brought into contact in a redox reaction. Each cell is also supplied with a heat transfer fluid, used to regulate the temperature of the electrochemical device. To allow fluids to pass through, the bipolar plate comprises concave portions and convex portions to form circulation channels.

With reference to FIG. 4, the bipolar plate B (shown in FIG. 13) according to the invention is formed from at least one non-woven carbon reinforcement film 2 and at least one thermoplastic resin film 3. In this example, the bipolar plate B is formed from a non-woven carbon reinforcement film 2 and a thermoplastic resin film 3. This document describes the example of a single non-woven carbon reinforcement film 2 and a single thermoplastic resin film 3, although it goes without saying that the number of films could be different. In particular, it goes without saying that the bipolar plate B could be formed from several non-woven carbon reinforcement films 2 and/or several thermoplastic resin films 3. Hereafter, for the sake of brevity, the non-woven carbon reinforcement film will be referred to as reinforcement film 2.

With reference to FIG. 5, the reinforcement film 2 preferably extends in a plane (X, Y) and has two substantially flat and parallel outer surfaces 2A and 2B, a lower surface 2A and an upper surface 2B. The reinforcement film 2 also comprises a plurality of reinforcement fibers 21. Preferably, the reinforcement fibers 21 are formed from carbon fibers. The thickness Ep2 of the reinforcement film 2 is defined along a vertical axis Z, orthogonal to the plane (X, Y).

Each reinforcement fiber 21 comprises a first end 21a and a second end 21b. At least some of the reinforcement fibers 21 of the reinforcement film 2 extend substantially, from the first end 21a to the second end 21b, along an axis of orientation F. The orientation axis F extends, in this example, from the lower surface 2A to the upper surface 2B. In other words, the first end 21a of the reinforcement fibers 21 is substantially on the surface of the lower surface 2A and the second end 21b is substantially on the surface of the upper surface 2B, and each reinforcement fiber 21 extends through the thickness Ep2 of the reinforcement film 2. Still referring to FIG. 5, the orientation axis F is defined by forming an angle Theta θ with the vertical axis Z and an angle Phi φ with the axis X, in a projection plane (X, Y). Preferably, the orientation axis F extends so that the angle Theta θ is less than 45° or greater than 135° and the angle Phi φ is between 45° and 135°. For the sake of clarity, when the reinforcement fibers 21 meet the above conditions, the reinforcement fibers 21 are considered to extend along the stack axis Z.

More specifically, the orientation axis F extends so that the angle Theta θ is between 0° and 45° or between 135° and 180° and the angle Phi φ is between 45° and 135°.

Preferably, between 10% and 60% of the reinforcement fibers 21 of the reinforcement film 2 extend along the stack axis Z between the lower surface 2A and the upper surface 2B of the reinforcement film 2, as shown in FIG. 5. Such an orientation of the reinforcement fibers 21 allows to increase the electrical conductivity and therefore, once manufactured, in the bipolar plate B while retaining significant mechanical characteristics. A high conductivity in the thickness of the reinforcement film 2, i.e., along the stack axis Z, is advantageous because it ensures a good conductivity in the thickness of the bipolar plate B, as will be described in more detail later. In one embodiment, the reinforcement fibers 21 are oriented along the stack axis Z by a method such as needling, stitching or sewing. Such methods are known to the person skilled in the art and will not be described in greater detail in this document. Alternatively, the orientation of the reinforcement fibers 21 can be carried out by a different method, for example by hydroentanglement.

By way of example, the orientation of the reinforcement fibers 21 in the reinforcement film 2 can be determined by analyzing images obtained by X-ray tomography. Such a method allows to obtain a three-dimensional 3D image of the reinforcement film 2 and to analyze the reinforcement fibers 21 independently of each other, in order to define their orientations in the reinforcement film 2.

More specifically, in this example, the reinforcement fibers 21 are defined by grey level thresholding in order to distinguish them from porosities. It involves filtering the 3D image in a contrast range that highlights the reinforcement fibers 21. “Morphological operator” type image treatment is used to identify the three-dimensional structure of the reinforcement fibers 21 in the image. Preferably, an image treatment of the “skeletonization” type, referred to as “morphological skeleton” or “Skeletonization” in English, is chosen. Such a method is known to the person skilled in the art and will not be described in greater detail in this document.

In one example, to determine the orientation of the reinforcement fibers 21 in the reinforcement film 2, the latter is analyzed by a micro-tomograph from the brand RX Solutions™, for example the EasyTom 230 model. The analysis was carried out with an accelerating voltage of 60 kV, a current of 80 μA and a Tungsten target. The exposure time is 0.4 s, averaged over 10 s, 1120 X-ray projections. The X-rays are acquired using X-Act software (RX Solutions™) and reconstructed in three dimensions using “Avizo for Industrial Inspection” software (Thermo Fisher Scientific™).

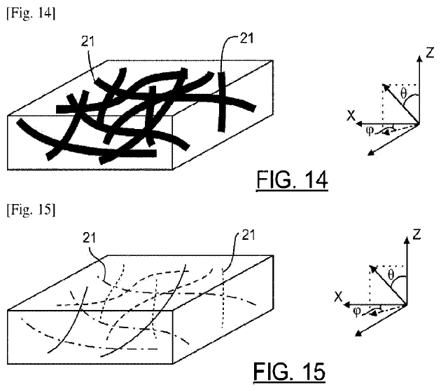

In particular, the following steps are carried out:
the images of the reinforcement film 2 from an X-ray tomography characterization are imported into Thermo Scientific™ software “Avizo Software”, a schematic representation of which is shown in FIG. 14,
the thresholding is performed over a range of contrasts to highlight the reinforcement fibers 21,
the three-dimensional filamentary structure of each reinforcement fiber 21 is identified by means of an “Auto Skeleton” module in the software, an example of which is shown in FIG. 15.

The properties of each reinforcement fiber 21 of the reinforcement film 2, such as their orientation, can then be studied. By way of example, in FIG. 15, the reinforcement fibers 21 with a similar orientation are represented by identical continuous or dotted lines.

As described previously, the orientation axis F of each reinforcement fiber 21 is defined by the angle Theta θ that it forms with the vertical axis Z and the angle Phi φ that it forms with the axis X of the reference frame (X, Y, Z). In this reference frame, the angles Theta θ and Phi φ vary between 0° and 180°. More precisely, in the reference frame (X, Y, Z), space is delimited by three distinct cones of angle 45° whose summit is the origin of the reference frame and which are centered on the axes X, Y and Z respectively. The three cones can therefore be defined by the following Theta θ and Phi φ pairs:
Cone oriented on Z: 45°<φ<135° and 0°<θ<45° or 135°<θ<180°
Cone oriented on Y: 45°<φ<135° and 45°<θ<135°
Cone oriented on X: 0°<φ<45° or 135°<φ<180° and 0°<θ<180°

The reinforcement fibers 21 are classified according to their orientations θ and φ between these three cones, the reinforcement fibers 21 belonging to two cones not being classified (fibers at the boundary between two cones). The ratio of reinforcement fibers 21 oriented along each axis X, Y and Z of the reinforcement film 2 can then be calculated.

In a preferred embodiment, the reinforcement film 2 is a carbon felt, also referred to as a “carbon mat”. A carbon felt allows the use of a material with a high ratio of open porosity, allowing an efficient exchange between the liquid electrolyte and the bipolar plate of the electrochemical device. By the expression “open porosity”, we mean an open cavity, i.e., not closed by the arrangement of the carbon reinforcement fibers 21 and/or by its sizing. Preferably, the ratio of open porosity in the reinforcement film 2 is greater than 70%. Even more preferably, the open porosity ratio is greater than 80%, which allows an optimum flow of the thermoplastic resin in the reinforcement film 2, allowing a good impregnation of the reinforcement fibers 21. Thanks to the high open porosity ratio of the reinforcement film 2, it is possible, after the manufacturing method, to obtain a bipolar plate B with a high level of consolidation (with a percentage of remaining porosities generally less than 1%). The carbon felt also has the advantage of being easy to deform, allowing the reinforcement film 2 to be adapted to complex forms. The carbon felt also has the advantage of requiring a lower forming pressure (generally between 6 and 10 MPa) than the forming pressure required for a woven reinforcement (commonly in excess of 15 MPa). Even more preferably, the non-woven carbon reinforcement film 2 comprises an open porosity ratio of more than 90%, allowing the manufacture of a bipolar plate B with optimum mechanical properties.

Preferably, the reinforcement film 2 comprises an open porosity ratio of more than 60%. In one embodiment, the reinforcement film 2 comprises an open porosity ratio of between 60% and 70%. In fact, certain materials such as carbon papers or gas diffusion layers, having such an open porosity ratio, allow to manufacture a light and resistant bipolar plate of thin thickness.

In a preferred embodiment, the reinforcement film 2 has porosities with a diameter of between 1 μm and 250 μm, allowing to impregnate the reinforcement fibers 21 effectively and to guarantee a high level of consolidation in the bipolar plate B manufactured. Preferably, at least 50% of the porosities have a diameter greater than 125 μm, and even more preferably greater than 150 μm.

“Diameter of the porosities” refers to the diameter of the equivalent circle of porosities, i.e., the diameter of a circle with a surface area equivalent to the surface area of a porosity. In one embodiment, the reinforcement film 2 has porosities with an equivalent circle diameter of between 1 μm and 300 μm.

In one embodiment, at least 50% of the surface area of the open porosities of the reinforcement film 2 is occupied by porosities whose equivalent circle diameter is greater than 30 μm, preferably greater than 80 μm, even more preferably greater than 90 μm.

For example, to characterize the porosities in the reinforcement film 2, one method is to use images obtained by X-ray tomography and analyze them in three or two dimensions. For example, a two-dimensional cut can be made in a desired direction. As described above, the reinforcement fibers 21 are defined by grey level thresholding in order to distinguish them from porosities. The image is then filtered using a range of contrasts allowing to highlight the reinforcement fibers 21. “Morphological operator” type image treatment (e.g., “morphological gradient”) is then used to identify the two-dimensional structure of the porosities in the image.

In practice, in one example, three-dimensional image slices from X-ray tomography are taken to obtain two-dimensional images. These two-dimensional images are imported in this example, into the software ImageJ™. The thresholding is then carried out on a range of grey levels between 120 and 255 (in a mode referred to as “Dark Background” mode). A morphological gradient operator in the software (in this example “Watershed”) can then be used to highlight the two-dimensional structure of the porosities.

Once the porosities have been identified, the area of each porosity is measured and the equivalent circle diameter is calculated from the measured area. The porosities are then characterized and classified according to their equivalent circle diameter. For example, the porosities are classified according to whether their equivalent circle diameter is less than or greater than a diameter threshold for a proportion of all porosities.

Preferably, the reinforcement film 2 is highly compressible, in order to adapt to the complex geometries of the fluid circulation channels of the bipolar plate. It is also possible to form a bipolar plate B with a thickness of less than 1 mm. Preferably, the bipolar plate B formed has a thickness of less than 0.5 mm, as will be described in more detail below.

Still referring to FIG. 5, the thickness of the reinforcement film 2 is Ep2, along the axis Z, preferably less than or equal to 5 mm. Preferably the thickness Ep2 is between 0.5 and 2.5 mm. Such a thickness Ep2 advantageously allows to limit the overall dimension of the bipolar plate B once it has been manufactured.

In a preferred embodiment, the reinforcement film 2 has a mass per unit area of less than or equal to 500 g/m². Preferably, the mass per unit area is between 50 and 300 g/m², allowing the use of a reinforcement film 2 with a limited mass, which allows to limit the mass of the bipolar plate B wherein the reinforcement film 2 is used. The bipolar plate B then has a limited mass, allowing it to be integrated into an electrochemical device configured to be mounted, for example, in an aircraft or any other vehicle.

The thermoplastic resin film 3 (shown in FIG. 4) comprises a polymer, designated thermoplastic resin 31, to form the thermoplastic matrix of the bipolar plate B after manufacture. For the sake of brevity, the thermoplastic resin film 3 will hereinafter be referred to as thermoplastic film 3.

Preferably, with reference to FIG. 4, the thermoplastic film 3 has a thickness Ep3 of between 50 and 600 μm. This thickness allows a sufficient quantity of thermoplastic resin 31 to form the thermoplastic matrix of bipolar plate B, while limiting the volume and the mass of the bipolar plate B.

In one embodiment, the thermoplastic resin of the thermoplastic film 3 is of the semi-crystalline type, allowing to give the bipolar plate B a highly impermeability to fluids, in particular to hydrogen. A semi-crystalline thermoplastic resin also provides a significant mechanical and chemical resistance, in particular a corrosion resistance. In one embodiment, the thermoplastic resin of the thermoplastic film 3 is of the amorphous type, allowing a greater ductility and a low ratio of dimensional shrinkage during the cooling step.

The thermoplastic resin can be adapted to suit the chemical environment of the electrochemical device wherein the bipolar plate B will be mounted. In this respect, for mounting the bipolar plate B in a low-temperature proton exchange membrane (referred by the acronym “PEM”), the thermoplastic resin is preferably of the polyphenylene sulphide type (referred by the acronym “PPS”), Polyphe-nylsulfone (referred by the acronym “PPSU”), Polyvinylidene fluoride (referred by the acronym “PVDF”), ethylene chlorotrifluoroethylene (referred by the acronym “ECTFE”) or of the polyolefin, polyaryl ether ketone or polyamide type.

For mounting the bipolar plate B in a high-temperature proton exchange membrane, the thermoplastic resin is preferably of the polyphenylene sulphide (PPS), polyphenyl sulphone (PPSU), ethylene chlorotrifluoroethylene (ECTFE) or polyaryl ether ketone type.

For mounting the bipolar plate B in a redox flow battery with vanadium or hydrogen bromide electrolyte, or any liquid electrolyte (organic for example), the thermoplastic resin is preferably of the polyphenylene sulphide (PPS) and polyphenylsulphone (PPSU) type if the electrolyte is of the basic type, and of the polyvinylidonc fluoridc (PVDF) or ethylene chlorotrifluo-roethylene (ECTFE) type if the electrolyte is of the acid type, or of the polyaryl ether ketone type.

A method for manufacturing a bipolar plate B according to one embodiment of the invention will now be described.

With reference to FIG. 4, the bipolar plate B is manufactured, in this example, from a stack 1 of a reinforcement film 2, a thermoplastic resin film 3 and two releasing films 4. The stack 1 extends along a stack axis A, as will be described in more detail below. The use of releasing films 4 allows to expose the reinforcement fibers 21 on the surface of the formed bipolar plate B and makes it electrically conductive. Preferably, the reinforcement film 2, the thermoplastic film 3 and the releasing film 4 are in roll form, making them easy to store and handle.

As shown in FIG. 6, the method comprises a first step of cutting E1 of the reinforcement film 2, the thermoplastic resin film 3 and the two releasing films 4 (only the reinforcement film 2 is shown in FIG. 6). The cutting is carried out manually on a cutting table, for example, and allows the various films to be cut to the dimensions of the final bipolar plate B required. The reinforcement film 2 and the thermoplastic film 3 preferably have similar dimensions. Even more preferably, each releasing film 4 has larger dimensions than the dimensions of the reinforcement film 2 and of the thermoplastic film 3, so that it protrudes from the stack 1 in order to be more easily removed after the bipolar plate B has been formed. It goes without saying that the cutting could also be carried out in a different way, for example using a punch or a robotic arm.

The method then comprises, with reference to FIG. 7, a second step of superimposing E2, along the stack axis A, the first releasing film 4, the reinforcement film 2, the thermoplastic film 3 and the second releasing film 4, in order to form the stack 1. Such positioning allows to orient the orientation axis F of the reinforcement fibers 21 of the reinforcement film 2 along the stack axis A, which allows to orient the reinforcement fibers 21 so that their ends 21a, 21b are exposed on two opposite faces of the bipolar plate B manufactured. The reinforcement fibers 21 thus optimally conduct electricity into the bipolar plate B and therefore into the electrochemical device wherein it will be mounted. In this example, the stack 1 can be formed either by successively positioning the first releasing film 4, the reinforcement film 2, the thermoplastic film 3 and the second releasing film 4, or by successively positioning the first releasing film 4, the thermoplastic film 3, the reinforcement film 2 and the second releasing film 4.

Alternatively, in the case of a stack 1 comprising two thermoplastic resin films 3, in this step an operator could just as easily superimpose successively a first releasing film 4, a first thermoplastic film 3, a reinforcement film 2, a second thermoplastic film 3 and a second releasing film 4. The use of two thermoplastic films 3 positioned on either side of the reinforcement film 2 allows to minimize the migration of the thermoplastic resin through the reinforcement film 2 and facilitates its impregnation.

The first releasing film 4, the reinforcement film 2, the thermoplastic film 3 and the second releasing film 4 can be superimposed manually or by means of a robotic arm, for example.

In one embodiment, the stack 1 is consolidated so as to limit the risks of one of the films shifting relative to the others, for example. Such consolidation can be achieved, for example, by the application of welding points (such as ultrasound or localized heating) or by sewing to secure all the films together. A consolidation in this way makes it easier to transport the entire stack 1, for example using a robotic arm comprising gripping means.

With reference to FIG. 8, the method then comprises a step E3 of positioning the stack 1 in a compression system, in this example in a mold M. The mold M comprises, in this example, a lower member and an upper member, each comprising an inner surface having an indentation G. The indentation G is used to form the fluid flow channels in the bipolar plate B. In one embodiment, before the stack 1 is positioned in the mold M, the latter is coated with a releasing agent, for example a liquid that can be sprayed onto the inner surface of each lower and upper member, so as to facilitate the subsequent releasing. Preferably, the mold M is at an initial temperature Ti. Preferably, the initial temperature Ti is between 2° and 210° C.

When the mold M is closed, trapping the stack 1, the temperature is gradually increased from the initial temperature Ti to a predetermined forming temperature Tm. Preferably, the forming temperature Tm is between 14° and 400° C. By way of example, for the thermoplastics of the PPS type, the forming temperature Tm is preferably between 305 and 340° C. For the PVDF-type thermoplastics, the forming temperature Tm is between 20° and 260° C., preferably between 21° and 240° C. For the thermoplastics of the PPSU type, the forming temperature Tm is between 24° and 360° C., preferably between 29° and 330° C. The temperature is raised from the initial temperature Ti to a predetermined forming temperature Tm is carried out for a first predetermined time Δt1 (shown in the graph in FIG. 11). Preferably, the first time Δt1 is less than 10 min, preferably less than or equal to 3 min, so as to quickly heat the mold M to save production time and achieve high output rates.

Referring to FIG. 9, the method then comprises a step of pressurizing E4 the stack 1 in the compression mold M. The pressurization step E4 is carried out at the forming temperature Tm, at a predetermined forming pressure Pm, for a second predetermined time Δt2 (shown in the graph in FIG. 11). The pressurization step E4 allows to melt the thermoplastic resin in the thermoplastic film 3 to impregnate the reinforcement film 2 and form a bipolar plate B.

Preferably, the forming pressure Pm is between 6 and 12 MPa. Even more preferably, the forming pressure Pm is between 8 and 10 MPa, allowing both to limit the deformation of the reinforcement fibers 21 in the initial reinforcement film 2, which could generate porous cavities in the bipolar plate B, and to apply the pressure simply. Preferably, the second time Δt2 is less than 2 min, preferably less than 1 min, so as to ensure that the reinforcement fibers 21 are impregnated with the thermoplastic resin 31 and thus limit the porosity of the bipolar plate B.

The method then comprises a cooling step E5, shown in FIG. 10, of the bipolar plate B formed, for a third predetermined time Δt3 (shown in the graph in FIG. 11), so as to consolidate it. The temperature drops from the forming temperature Tm to a release temperature Tr, at which the pressurization is stopped. Preferably, the release temperature Tr is equal to the initial temperature Ti. The third predetermined time Δt3 is set, in the case of semi-crystalline polymers, to obtain a cooling rate of between 10 and 100° C./min, allowing a sufficiently slow cooling to allow the crystalline part of the thermoplastic resin to develop, thereby ensuring that the bipolar plate manufactured will have a low permeability to hydrogen or any other fluid used in an energy conversion system, while minimizing the cooling times in order to reduce the manufacturing cycles. At this cooling rate, a crystallinity ratio of between 43 and 47% is obtained. Even more preferably, the cooling rate is between 4° and 90° C./min, which ensures an optimum crystallization of the thermoplastic resin during the consolidation phase. In the case of amorphous polymers, the cooling rate is preferably greater than 80° C./min, so as to rapidly cool the bipolar plate B and the mold M and speed up the production rates.

The forming cycle (i.e., the temperature rise, the forming step and the cooling step) is shown in FIG. 11, which shows a graph of the evolution of the temperature T and of the pressure P as a function of the time t during a complete forming cycle, as described above.

When the release temperature Tr is reached, the mold M is opened, and the bipolar composite plate B formed is removed.

As shown in FIG. 12, the releasing films 4 are then removed, in a step E6, on either side of the bipolar plate B that has been manufactured, so as to expose the reinforcement fibers 21 on the surface of the bipolar plate B. The removal of the releasing films 4 can be carried out manually or automatically by winding the releasing film 4 on leaving the mold, for example.

In one example of implementation, the method comprises a step of cutting the bipolar plate B, for example to remove the peripheral part of the bipolar plate that has manufacturing defects. This can be done, for example, by water jet cutting, milling or using a punch. Preferably, a centering is taken into account to ensure an accurate cutting of the bipolar plate (cutting error less than or equal to 0.1 mm).

FIG. 13 shows a bipolar plate B formed by the manufacturing method described above. The bipolar plate B extends in a plane (X, Y). Advantageously, such a method allows to form a bipolar plate B with a thickness Ep (along the axis Z, orthogonal to the plane (X, Y)) of less than 1 mm. Preferably, the bipolar plate B formed has a thickness Ep of less than 0.5 mm.

Preferably, the proportions between the quantity of reinforcement fibers 21 and thermoplastic resin 31 in the final bipolar plate B are such that the electrical, thermal and mechanical properties of the bipolar plate B meet the requirements of the applications of the electrochemical devices. The final bipolar plate B therefore preferably has a volume ratio of reinforcement fibers 21 of between 20 and 60%, and a volume ratio of thermoplastic matrix 31 of between 40 and 80%. Preferably, the volume ratio of reinforcement fibers 21 is between 30 and 50%, and that of the thermoplastic matrix 31 between 50 and 70%. The very thin bipolar plate produced in this way allows to compensate for a lower ratio of conductive elements than in the manufacturing methods of the prior art, wherein the ratio of conductive elements is greater than 80%, while ensuring an optimum conductivity. The mass of the bipolar plate manufactured is also reduced, allowing to limit the mass of the electrochemical device wherein the bipolar plate will be mounted.

For example, the volume ratio of reinforcement fibers 21 present in the bipolar plate B after manufacture can be determined after separation of the thermoplastic matrix 31. This separation can be achieved by acid dissolution of the thermoplastic matrix 31 or by calcination, for example. The mass of the conductive reinforcement fibers 21 is then measured by weighing and related to the initial mass of the material. The volume ratio of the materials is used to convert to a volumetric mass.

The method according to the invention describes a suitable type of carbon reinforcement and the associated manufacturing cycles, in order to provide a method for manufacturing a bipolar plate that is simple, fast and does not require the use of expensive industrial machinery, while allowing the formation of a thin, lightweight bipolar plate.

Preferably, the bipolar plate has a thickness of less than or equal to 0.4 mm, which advantageously allows both to limit the mass and the overall dimension of the electrochemical device and to increase its power density (kW/kg), without having to post-treat the surface of the material in order to increase its electrical conductivity. The electrochemical device can therefore be easily mounted in a vehicle such as an aircraft.

In a preferred manufacturing example, the present invention allows to manufacture a flexible bipolar plate B with a specific electrical surface resistance (ASR, acronym for Area Specific Resistance) of less than 12 mΩ·cm2 and a porosity ratio of less than 1%. Advantageously, these characteristics ensure a permeability of less than 5×10A−8 mol/m/s/MPa and a high hydrophobicity of the surface of the bipolar plate B, with contact angles greater than 110°.

The porosity ratio of the manufactured bipolar plate B can be measured in various ways known to the person skilled in the art.

For example, the method of pushing Archimedes or the Pycnometer analysis can be used to measure the actual density of the bipolar plate B and compare this actual density with a theoretical density. These two methods allow to accurately determine the exact volume of a sample and, knowing its mass, to deduce its volumetric mass.

In a second example, different image analysis methods can be used to distinguish the porosities in the bipolar plate B. In this case, the volume of the porosities is identified on a three-dimensional image (or their surface on a two-dimensional image), in a similar way to the method described above for the reinforcement film 2.

In a third example, wave absorption methods such as X-ray tomography or the use of ultrasound can also be used to determine the porosity ratio of the final bipolar plate B.

These methods are usually followed by a measurement of the exact composition of the sample of interest. To do this, the reinforcement fibers 21 are separated and weighed independently of the thermoplastic matrix 31. This separation can be achieved by dissolution of the matrix or by its thermal degradation (calcination or combustion) or chemical degradation (acid dissolution). Knowing the masses and volumetric masses of the initial elements of the bipolar plate B, it is possible to deduce the corresponding volumes. These volumes are compared with the exact volume of the sample and the remaining volume corresponds to the volume of the porosities.

The volume ratio of porosities Tᵥ_{ₚ} is calculated according to the following formula, wherein mₜ corresponds to the mass of reinforcement fiber 21 obtained, for example, after acid dissolution of the thermoplastic matrix 31, p_{f} corresponds to the volumetric mass of the reinforcement fiber 21 and, pᵣ to that of the thermoplastic matrix 31:

$${Tv}_{p} = \frac{{V}_{p}}{{V}_{t}} = 1 - \frac{{m}_{f}}{{ρ}_{f} \times {V}_{t}} - \frac{{m}_{t} - {m}_{f}}{{ρ}_{r} \times {V}_{t}}$$

1-13. (canceled)

14. A method for manufacturing a bipolar plate, the bipolar plate being configured to be mounted in an electrochemical device, the electrochemical device being configured to implement an electrochemical reaction, the method comprising:
a step of superimposing, along a stack axis Z, a first releasing film, at least one reinforcement film, at least one thermoplastic resin film and a second releasing film, in order to form a stack,
a step of positioning the stack in a compression system,
a step of pressurizing the stack in the compression system, the pressurizing step being carried out at a predetermined forming pressure and at a predetermined forming temperature for a second predetermined time, so as to melt the thermoplastic resin of the thermoplastic resin film and impregnate the reinforcement film with the thermoplastic resin to form a bipolar plate,
manufacturing method wherein the reinforcement film is a non-woven carbon reinforcement film comprising a plurality of reinforcement fibers, each reinforcement fiber extending along an axis of orientation, the ratio of reinforcement fibers oriented along the stack axis Z is between 10% and 60%.

15. The method for manufacturing according to claim 14, wherein the ratio of reinforcement fibers oriented along the stack axis Z is between 15% and 45%.

16. The method for manufacturing according to claim 14, wherein the non-woven carbon reinforcement film is a carbon felt.

17. The method for manufacturing according to claim 14, wherein the non-woven carbon reinforcement film comprising open porosities, the non-woven carbon reinforcement film has an open porosity ratio greater than 60% before the pressurization step.

18. The method for manufacturing according to claim 17, wherein said open porosities have a diameter of between 1 μm and 300 μm.

19. The method for manufacturing according to claim 14, wherein the forming temperature is between 14° and 400° C.

20. The method for manufacturing according to claim 14, wherein the predetermined forming pressure is between 6 and 12 MPa.

21. The method for manufacturing according to claim 14, comprising, subsequent to the pressurization step, a step of cooling the formed bipolar plate, for a third predetermined period of time,

22. The method for manufacturing according to claim 21, wherein the cooling rate is between 4° and 90° C./min.

23. A bipolar plate, configured to be mounted in an electrochemical device, the bipolar plate being manufactured by the method for manufacturing according to claim 1.

24. The bipolar plate according to claim 23 having a thickness less than or equal to 0.5 mm.

25. The bipolar plate according to claim 23 having a specific electrical surface resistance of less than 12 mΩ·cm².

26. The bipolar plate according to claim 23 having a porosity ratio of less than 1%.
